(19) United States
(12) Patent Application Publication
(10) Pub. No.: US 2015/0290650 A1
(43) Pub. Date: Oct. 15, 2015

(54) METHOD FOR GENERATING HIGH SPHERICITY SEED AND FLUIDIZED BED GRANULAR SILICON

(71) Applicant: Jiangsu Zhongneng Polysilicon Technology Development Co., Ltd., Xuzhou, Jiangsu (CN)

(72) Inventors: David Mixon, Fairless Hills, PA (US); Christopher Nelan, Fairless Hills, PA (US)

(21) Appl. No.: 14/418,790

(22) PCT Filed: Aug. 13, 2013
(86) PCT No.: PCT/CN2013/081356

§ 371 Date: Jan. 30, 2015

Related U.S. Application Data
(60) Provisional application No. 61/682,549, filed on Aug. 13, 2012.

(51) Int. Cl. B02C 4/02; B02C 23/16; B02C 4/28

(52) U.S. Cl. CPC B02C 4/02; B02C 4/286; B02C 23/16

(57) ABSTRACT

The present invention discloses a method for generating high sphericity seed for the operation of a fluidized bed reactor to produce granular polysilicon. The method comprises: using fluidized bed granular silicon as a raw material, passing through a roll crusher apparatus to fracture, the roll crusher apparatus comprises at least one set of rollers, by adjusting the roller gap width between the sets of rollers, the silicon particles which size larger than the roller gap width are crushed, the silicon particles which size smaller than the roller gap width directly pass through the gap, thereby generating the high sphericity seed, then recycle back into fluidized bed reactor for reaction and generate granular silicon. According to the present invention, the generating seeds have a high sphericity and narrow PSD, compared to the low sphericity seeds, the porosity of the FBR in present invention is lower, and easier to avoid the formation of silicon powder and other negative impact.

### FIELD OF THE INVENTION

This invention relates to the production of polysilicon, it also relates to the method for generating high sphericity seed for the operation of a fluidized bed reactor to produce granular polysilicon.

### BACKGROUND OF THE INVENTION

Polysilicon is a key raw material in photovoltaic industry and electronic information industry, and is an important product to realize the country's new energy strategy. Since year of 2015, With the rise and prosperity of the photovoltaic industry, China's polysilicon industry is also experienced leaping development. But from this year, faced with the major shrinking PV market in European, and situation of the “double reverse” launched by Europe and America, how to achieve grid parity is the key initiatives to protect the industry to develop, in which the basic raw material polysilicon costs down is crucial.

Basically, the method of preparing polysilicon includes modified Siemens, metallurgy, fluidized bed reactor (FBR), and so on. FBR is a polysilicon technology which is developed by Union Carbide company in the United States. In this method, SiCl₄, H₂, HCl and silicon are used as material, SiHCl₃ (TCS) is generated in the FBR(bubbling bed) under high temperature and pressure condition, SiH₂Cl₂ is generated by the disproportionation of SiHCl₃, then silane is generated by the disproportionation of SiH₂Cl₂. Silane or chlorosilane is introduced into FBR with granular silicon seeds(seed) under 500° C.˜1200° C., the thermal decomposition reaction is carried out continuous, and granular polysilicon is produced. In accordance with the type of silicon-containing gas introduced into the FBR, the FBR is usually divided into silane and chlorosilane FBR (such as TCS-FBR). Since the surface area participating in the reaction of silicon particles in FBR is large, so that this method is high production efficiency, low power consumption and low cost. Another advantage of FBR is, in downstream crystal growth process, the silicon particles can be directly loaded into the crystal growth crucible, but the traditional modified Siemens production of polysilicon rod products need crushing and sorting treatment before loading into the crucible, also need other treatments. For example, high-purity inorganic acid etching, washed with ultrapure water, drying and processing in a clean environment, and so on. Thus, compared with the modified Siemens, energy consumption of FBR process is very low, deposition efficiency is high, continuous operation is capable. The granular silicon product is beneficial for downstream use, wafer manufacturing cost can be reduced, thus, the current cost of production of photovoltaic cell is reduced significantly.

It is desirable to maintain a steady-state, largely spherical shape factor for the particles within the fluidized bed in order to ensure consistent, continuous FBR operation and performance for a fixed feed rate of fluidizing gas. The fluidization of particles with higher sphericity will increase the minimum fluidization velocity for the fluidized bed, in comparison to the use of particles with lower sphericity. This also has the desirable effect of reducing the reactor diameter required for the use of a fixed fluidizing gas feed rate and fixed ratio of U_{g}/U_{mf}, where U_{g} is the superficial velocity of fluidizing gas and U_{mf} is the minimum fluidization velocity. Thus, preparation of high spherical seed is crucial for FBR performance and long-term stable operation.

Silicon seed particles are usually prepared by sieving, grinding, crushing, etc. For example, in accordance with the particle size, the FBR silicon particles are filtered, the qualified silicon particles are as product to package, substandard silicon particles are recycled directly back to the FBR. The sieving method usually sieves large particles, then small particles, its raw material utilization is low, material handling capacity and seed production are limited. The grinding method is easy to produce dust, causing inconvenience to the separation and subsequent use of the seeds. The crushing method is also referenced like crushing a polysilicon rod, but only low sphericity seeds can be prepared, i.e. the most seeds prepared are irregular shape. This irregular composition is unfavorable in a fluidized bed due to its abnormal fluidization characteristics and reduced minimum fluidization and slugging velocities. This can cause increased elutriation of particles from the FBR and a greater void space within the bed. Erratic levels of fluidization and increased bubble phase will also promote unwanted formation of sub-micron fines, resulting from the “free-space”, or homogeneous, gas phase decomposition of silicon source gas (e.g. SiHCl₃, SiH₂Cl₂, SiHBr₃, SiH₂Br₂, and SiH₄). These fines are undesirable due to the potential for plugging of downstream equipment and piping, if not filtered properly. The fines also have an extremely high surface-area-to-volume ratio, are susceptible to surface contamination, and can therefore contaminate the growing granules by physical incorporation into their structure during the growth process.

Although greater non-sphericity of the particles will result in a lower minimum fluidization velocity during continuous operation, an increased gas feed rate is required to initially fluidize such particles from a packed bed condition, in comparison to the fluidization of more spherical particles. As such, an abnormally high pressure drop across the bed will be experienced until the irregularly shaped particles have become “unlocked” and complete fluidization is achieved. Moreover, once fluidization is reached the porosity of the bed for a more non-spherical mixture of particles will be greater than that for a more spherical mixture. As mentioned, this creates the unwanted propensity for fines formation. Furthermore, particles that exhibit sharp-edges are more susceptible to unwanted dust formation, through abrasion and attrition mechanisms. Therefore, to avoid the aforementioned negative factors, still need a method to prepare high sphericity seed, the process should be simple and can meet the industrialized mass production, without creating dust, resulting seed with a narrow particle size distribution.

### SUMMARY OF THE INVENTION

One object of present invention is to provide a process for preparing a high sphericity seed, comprising the FBR granular silicon particles prepared are used as a raw material, through a roller apparatus which carrying out roller crusher step, according to the invention method, the seeds prepared have high sphericity and narrow size distribution.

Another object of present invention is to provide a method for preparing granular silicon using the foregoing high sphericity seed to recycle back to FBR for preparing granular silicon.

In order to achieve the above objects and technical effects, the present invention includes the following technical solutions:

A method for generating high spherical seed, comprising using a certain particle size distribution (PSD) range of granular silicon as a raw material, passing through a roll crusher apparatus to fracture, characterized in that: the roll crusher apparatus comprises at least one pair of rollers, by adjusting the gap width between the sets of rollers, the silicon particles which size larger than the roller gap width are crushed, the silicon particles which size smaller than the roller gap width directly pass through the gap, thereby generating the high sphericity seed. The granular silicon can be granular silicon prepared in a FBR, can be used as raw material directly, which feeding into roll crusher for generating the seed without any pretreatment. It should be understood by those skilled in the art that the granular silicons removed from FBR have a certain particle size distribution range. As is well known, the raw material of generating seed can also be prepared by other methods, but FBR method is preferred.

In a preferred embodiment, the roller gap width x, the median diameter d₅₀ of granular silicon raw material and the median diameter D₅₀ of target seed satisfy the following relationship: 100 μm<D₅₀<d₅₀<x<2400 μm, wherein the granular silicon PSD dₚ is 100 μm˜2400 μm.

In a preferred embodiment, the roll crusher apparatus comprises two sets of rollers, the two sets of rollers positioned vertically, the raw material of granular silicon products pass through two pairs of rollers. More preferred, the upper roll gap width x₁ and lower roll gap width x₂ satisfy the following relationship: x₁≧x₂, wherein x₁ is the upper roll gap width, x₂ is the lower roll gap width. Another aspect of the present invention, a method for generating fluidized bed granular silicon is disclosed in this invention, comprises the following procedures:

1) silicon source gas and fluidized gas are introduced into fluidized bed reactor within the silicon seeds are loaded, where the thermal decomposition reaction is carried out continuously under 500° C.˜1200° C. reaction temperature, and the granular silicon products are prepared from depositing silicon on the surface of silicon seeds;

2) portion of the granular silicon products prepared withdrawal of FBR are sent to package as the final product;

3) portion of the granular silicon products withdrawal of FBR are sent to generate the high spherical granular silicon seeds by any methods of claim 1-5, and the seeds are recycled back into FBR, in order to maintain the number of particles constant within the fluidized bed.

Wherein, the silicon source gas can be selected from SiHₐX_{b}, wherein, X=F, Cl, Br, I, a or b is selected independently from a=0˜4, b=0˜4, and a+b=4.

In a preferred embodiment, the silicon source gas is silane.

In another preferred embodiment, the silicon source gas is chlorosilane. It is preferred, the silicon source gas is TCS.

According to the present invention for generating high sphericity seed, a certain particle size distribution (PSD) range of granular silicon product are as a raw material, passing through a roll crusher apparatus to fracture, by adjusting the gap width between the sets of rollers to satisfy the following relationship: 100 μm<D₅₀<d₅₀<x<2400 μm, the silicon particles which size larger than the roller gap width are crushed, the most silicon particles which size smaller than the roller gap width directly pass through the gap and maintain their spherical morphology, thus most seeds are spherical morphology, thereby generating the high sphericity seed. The present invention can also be disclosed that according to the PSD of silicon particles for raw material, to adjust the gap width between the sets of rollers, in order to obtain high sphericity seed with certain size and narrow PSD rang.

According to the present invention for generating high sphericity seed, the high spherical seed can be obtained by roller apparatus through only once treatment. Compared to sieving method, the present invention is easier, without classification sieving, can save much more time; can crush large particles by crush rollers, and small particles pass through directly, which handle a large amount of raw materials and all the raw materials are converted to seeds, its raw material utilization is higher. Compared to grinding method, the present invention does not produce sub-micron fines, the seed prepared has a high sphericity and a narrow PSD range.

According to the present invention for generating high sphericity seed and fluidized bed granular silicon, the generated seeds with high sphericity and narrow PSD range are recycled back into FBR, this composition of seeds are favorable to maintain the smooth operation of the fluidized bed, prolong the operating cycle of the fluidized bed. Meanwhile, the porosity of the bed is small, thus the free space and formation of silicon fines by homogeneous nucleation which will cause downstream pipeline blocked or contamination of the product, or other issues are avoided.

### BRIEF DESCRIPTION OF THE DRAWINGS

FIG. 1 is a schematic diagram of the apparatus for generating high sphericity seed of the present invention.

FIG. 2 is another schematic diagram of the apparatus for generating high sphericity seed of the present invention.

FIG. 3 is a simplified process flow schematic diagram for the operation of a fluidized bed reactor and seed generation of the present invention.

FIG. 4 is a graph showing minimum fluidization velocity vs. sphericity.

FIG. 5 is the PSD schematic diagram of the feed granular silicon to the roll crusher in example 1.

FIG. 6 is the PSD columnar schematic diagram of feed granular silicon before crushing and seed after crushing in example 1.

FIG. 7 is the PSD curve of feed granular silicon before crushing and seed after crushing in example 1.

FIG. 8 is the image of the feed granular silicon particles in example 1.

FIG. 9 is the image of the seeds generated after feed granular silicon crushing in Example 1.

FIG. 10 is the PSD columnar schematic diagram of feed granular silicon before grinding and seed after grinding in comparative example 1.

FIG. 11 is the PSD curve of feed granular silicon before grinding and seed after grinding in comparative example 1.

FIG. 12 is the image of the feed granular silicon particles in comparative example 1.

FIG. 13 is the image of the seeds generated after feed granular silicon grinding in comparative example 1.

FIG. 14 is a direct comparison of seed PSD's from an embodiment of the invention described in example 1 and comparative example 1.

Wherein, 1—FBR, 2—granular silicon, 3—package, 4—roll crush apparatus, 5—granular silicon product, 6—seed, 7, 7′—roller

### DETAILED DESCRIPTION

Furthermore, the foregoing descriptions of the embodiments according to the present invention are provided for illustration only, and not for the purpose of limiting the invention as defined by the appended claims and their equivalents.

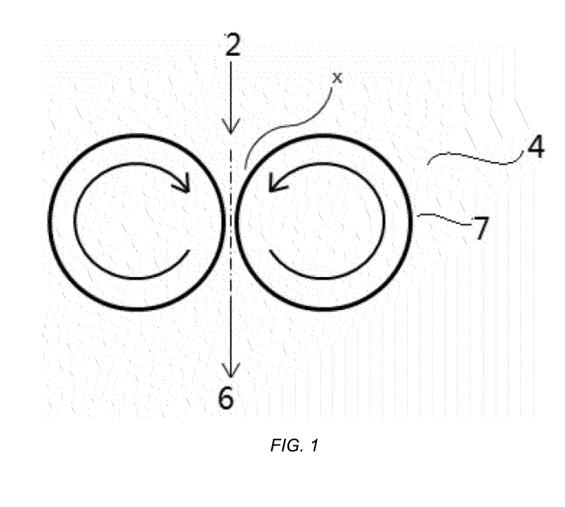

FIG. 1 shows a embodiment of the apparatus for generating high sphericity seed of the present invention. A method for generating high sphericity seed, using a certain particle size distribution (PSD) range of granular silicon 2 as a raw material, passing through a roll crusher apparatus 4 to fracture, the roll crusher apparatus comprises at least one pair of rollers, the roll crusher apparatus comprises a set of rollers 7, each set of rollers 7 includes two opposite rotation of rollers. By adjusting the gap width x between the sets of rollers, the silicon particles which size larger than the roller gap width x are crushed, the most silicon particles which size smaller than the roller gap width x directly pass through the gap. As the prepared seeds are the composition of crushed silicon particles and silicon particles which pass through the gap directly, wherein the most are uncrushed, so the prepared seeds have a high sphericity.

Actually, the particle size range dₚ of granular silicon emptied from FBR is, but not limited to 100 μm˜2400 μm, it has a broad PSD range. But a narrow PSD range seeds can be obtained by adjusting the gap width x. In the present invention, The sphericity is that the prepared spherical morphology seed number ratio of total seed number, the more the proportion of the spherical seed number, the greater the sphericity.

About the roll crusher apparatus, the prior art can be referred. For example, Wacker's patent application US20090114748A1 discloses a roll crusher apparatus, it comprises a set of rollers, each set of rollers includes two opposite rotation of rollers, covering a hard metal coating on the surface of the roller, such as but not limit to WC. The difference is that the roll crusher apparatus is used to crush the polysilicon rods totally in Wacker's patent, and the almost size of a small silicon block are obtained. But in the present invention, the apparatus for generating high sphericity seed, needs to adjust the roller gap width according to the feed silicon PSD range, then the feed silicon particles feed into the roll crusher apparatus and are crushed.

In an embodiment, the feed granular silicon PSD range for the roll crusher apparatus is 100 μm˜2400 μm, the roller gap width can be adjusted according to the feed silicon PSD range. Rather than feeding the roll crusher with only large particles including, but not limited to, particles greater than 1500 μm that will all be crushed by a 1500 μm or smaller effective gap width x setting, intermediate sized particles including, but not limited to, particles ranging from 100 to 1500 μm are also included in the feed which are unaffected by the crushing and maintain their original spherical morphology. In an embodiment, rather than feeding the roll crusher with only large particles including, but not limited to, particles greater than 1250 μm that will all be crushed by a 1250 μm or smaller effective gap width x setting, intermediate sized particles including, but not limited to, particles ranging from 100 to 1250 μm are also included in the feed which are unaffected by the crushing and maintain their original spherical morphology. In an embodiment, rather than feeding the roll mill with only large particles including, but not limited to, particles greater than 1000 μm that will all be crushed by a 1000 μm or smaller effective gap width x setting, intermediate sized particles including, but not limited to, particles ranging from 100 to 1000 μm are also included in the feed which are unaffected by the crushing and maintain their original spherical morphology. In an embodiment, rather than feeding the roll mill with only large particles including, but not limited to, particles greater than 750 μm that will all be crushed by a 750 μm or smaller effective gap width x setting, intermediate sized particles including, but not limited to, particles ranging from 100 to 750 μm are also included in the feed which are unaffected by the crushing and maintain their original spherical morphology. In an embodiment, rather than feeding the roll mill with only large particles including, but not limited to, particles greater than 1750 μm that will all be crushed by a 1750 μm or smaller effective gap width x setting, intermediate sized particles including, but not limited to, particles ranging from 100 to 1750 μm are also included in the feed which are unaffected by the crushing and maintain their original spherical morphology. In an embodiment, rather than feeding the roll mill with only large particles including, but not limited to, particles greater than 2000 μm that will all be crushed by a 2000 μm or smaller effective gap width x setting, intermediate sized particles including, but not limited to, particles ranging from 100 to 2000 μm are also included in the feed which are unaffected by the crushing and maintain their original spherical morphology. In an embodiment, rather than feeding the roll mill with only large particles including, but not limited to, particles greater than 2000 μm that will all be crushed by a 2000 μm or smaller effective gap width x setting, intermediate sized particles including, but not limited to, particles ranging from 100 to 2000 μm are also included in the feed which are unaffected by the crushing and maintain their original spherical morphology. In an embodiment, rather than feeding the roll mill with only large particles including, but not limited to, particles greater than 2250 μm that will all be crushed by a 2250 μm or smaller effective gap width x setting, intermediate sized particles including, but not limited to, particles ranging from 100 to 2250 μm are also included in the feed which are unaffected by the crushing and maintain their original spherical morphology. In an embodiment, rather than feeding the roll mill with only large particles including, but not limited to, particles greater than 2400 μm that will all be crushed by a 2400 μm or smaller effective gap width x setting, intermediate sized particles including, but not limited to, particles ranging from 100 to 2400 μm are also included in the feed which are unaffected by the crushing and maintain their original spherical morphology.

In an embodiment, according to the median diameter d₅₀ of feed granular silicon and the median diameter D₅₀ of target seed, the roller gap width x may be adjusted to optimize the sphericity of the seed stock. As well known, D₅₀ refers to a corresponding diameter when the cumulative percentage of the particle size distribution of a sample reaches 50%. Its physical meaning that the particle size greater than it reaches 50%, and particles smaller than it also reaches 50%, So in general, D₅₀ is also called median diameter or median particle size. In present invention, in order to distinguish easily, the median diameter of feed granular silicon with certain PSD is noted as d₅₀, and the median diameter of target seed by crushing is noted as D₅₀. Once the raw material for generating seed is selected, the PSD range of the raw material can be determined by detecting and computing. In present invention, in a preferred embodiment, the roller gap width x, the PSD dₚ and median diameter d₅₀ of feed granular silicon, and the median diameter D₅₀ of target seed satisfy the following relationship: 100 μm<D₅₀<d₅₀<x<2400 μm, wherein the granular silicon PSD dₚ is but not limit to 100 μm˜2400 μm, for example dₚ can be selected from 50 μm˜3000 μm. It will be appreciated that those skilled in the art, the PSD of granular silicon product removed from FBR can be analyzed and calculated through online particle size analyzer, and can be calculated the median particle size, so it's purposeful for adjusting the size of the roller gap width x.

In one embodiment, while the PSD range of the feed granular silicon is 100 μm˜2400 μm, its median diameter is 1500 μm, by adjusting the roller gap width x larger than 1500 μm, then the particles larger than 1500 μm are all crushed, and the ratio of crushed particles is smaller than 50%. In this embodiment, the most silicon particles pass through the roll crusher directly and uncrushed, and maintain their original spherical morphology. The seeds prepared are the composition of uncrushed particles and crushed particles, but the most are the uncrushed ones, so the seeds prepared have a high sphericity. So while the median diameter is but not limit to 1250 μm, 750 μm, 1750 μm, 2000 μm or 2250 μm, and so on, by adjusting the roller gap width x larger than the corresponding median diameter, then most of the granular silicon pass through the roll crusher apparatus uncrushed, so can increase the sphericity of the seeds.

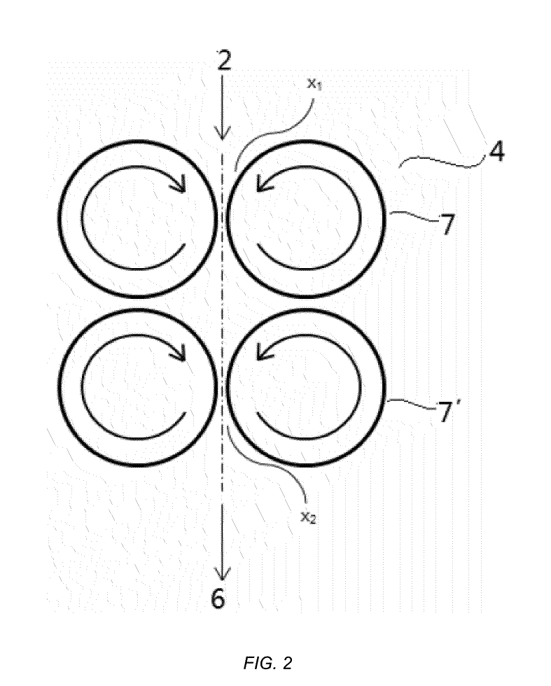

In a preferred embodiment, FIG. 2 shows another schematic diagram of the apparatus for generating high sphericity seed of the present invention. The roll crusher apparatus comprises two sets of rollers 7 and 7′, the two sets of rollers positioned vertically, the raw material of granular silicon products pass through two sets of rollers. More preferred, the upper roller gap width x₁ and lower roller gap width x₂ satisfy the following relationship: x₁≧x₂, wherein x₁ is the upper roll gap width, x₂ is the lower roll gap width. The lower rollers can be used to adjust the PSD range and sphericity of the target seed narrowly. For example, to adjust the lower roll gap width x₂ according to the target seed size, preferred is but not limit to D₅₀<x₂<x₁. In one embodiment, while the median diameter of feed granular silicon d₅₀ is 1500 μm, and the median diameter of target seed D₅₀ is 800 μm, according to the foregoing description, x₁ is needed to adjust to 1500 μm<x₁<2400 μm, then x₂ adjust to 800 μm<x₂<1500 μm, so the narrower PSD and higher sphericity seeds are obtained by adjusting the lower roller gap width x₂. As well known, the roll crusher apparatus can also comprise more sets of rollers, such as but not limit to three sets, four sets, five sets or six sets, and so on. It can be installed and adjusted according to the requirement of target seed, it also can be used through several sets of rollers in series or parallel to improve the efficiency of preparation for seed.

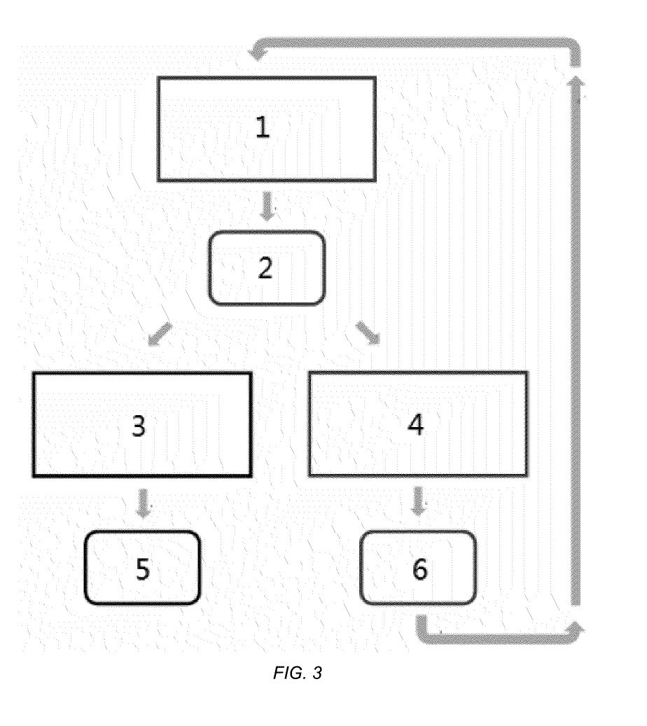

Another aspect of the present invention, FIG. 3 shows a simplified process flow schematic diagram for the operation of a fluidized bed reactor and seed generation of the present invention. In the embodiment, the crushing method is used to generate the fluidized bed granular silicon seed. In the FBR 1, the thermal decomposition reaction of silicon source gas is carried out and silicon is deposited on the surface of seeds, the high pure granular silicon products 2 are produced continuously. Portion of the granular silicon products 2 are sent to package 3 as the final product 5. In order to generate seed, portion of the granular silicon products 2 withdrawal of FBR are sent to generate the high spherical granular silicon seeds 6 by a set of roll crusher apparatus 4, the PSD of the particles are decreased. The seeds 6 are recycled back into FBR 1, and the granular silicon products 2 withdrawal of FBR continuously or semi-continuously. This seed recycle process is necessary in order to maintain the number of particles and PSD constant within the fluidized bed for prolonged continuous or semi-continuous operation, as silicon deposited on the particles within the reactor increases the diameter and sphericity of the particles as they grow larger. The recycle rate (percentage of product that is ground to seed and recycled back to the FBR), PSD and sphericity of the recycle material, initial bed PSD and sphericity, and deposition rate are the primary determinants of the steady-state PSD and sphericity of the fluidized bed. Thus, it's very important for maintaining performance and smooth operation of the FBR by preparing the narrow PSD and high sphericity seeds and recycling into the FBR smoothly. In comparison, the conventional sieving, grinding and other methods can not satisfy this requirement. Only through the present invention of roll crushing method, by controlling the above mentioned recycle rate, preparing a narrow PSD and high sphericity seed, the above technical result will be achieved, then a fluidized bed reactor long-term stable operation can be achieved.

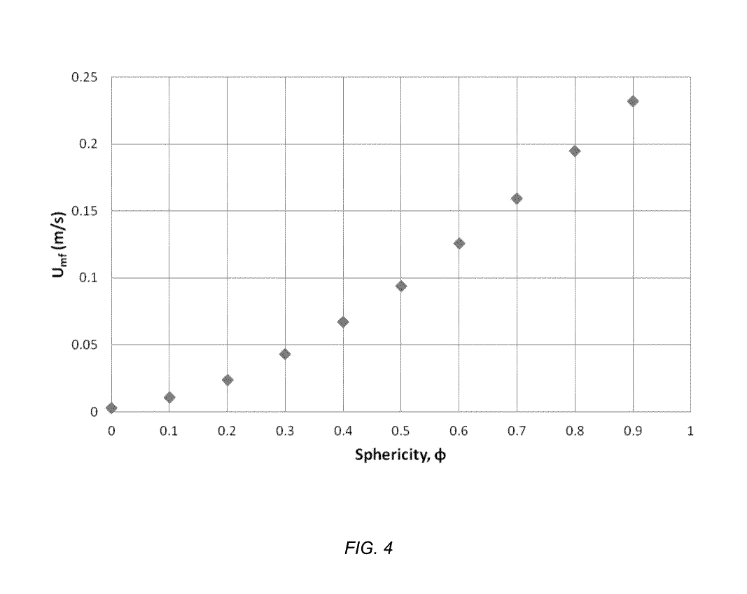

Otherwise, the sphericity of seeds is higher, the minimum fluidization velocity for FBR is greater. FIG. 4 shows a graph showing minimum fluidization velocity vs. sphericity for a given seed distribution with d₅₀ of 850 μm. Here, U_{mf} was calculated using Equation 1 (Ergun Equation).

$$\frac{Δ P}{L} = \frac{150 {μ ( 1 - ɛ )}^{2}}{{ɛ}^{3} {Φ}^{2} {d}_{p}^{2}} {U}_{0} + \frac{1.75 ( 1 - ɛ ) ρ}{{ɛ}^{3} Φ {d}_{p}} {U}_{0}^{2}$$

As can be seen from FIG. 4, with the sphericity of the seeds increases, the minimum fluidized velocity U_{mf} for FBR also increases. While a fixed fluidized gas inlet velocity and fixed U_{g}/U_{mf} are needed in one case, it has a significant effect to reduce the diameter of the fluidized bed reactor.

In present invention, the silicon source gas can be selected from SiHₐX_{b}, wherein, X=F, Cl, Br, I, a or b is selected independently from a=0˜4, b=0˜4, and a+b=4. In a preferred embodiment, the silicon source gas is silane or chlorosilane. It is preferred, the silicon source gas is but not limit to TCS. For example, it can be selected from SiH₄, SiH₂Cl₂, SiHCl₃, SiCl₄, SiH₂Br₂, SiHBr₃, SiBr₄, SiH₂I₂, SiHI₃, SiI₄ and their mixture. It will be appreciated that those skilled in the art, the silicon source gas can be selected from Si₂H₆, SiₙH₂ₙ₊₂, and so on. The silicon source gas can mix with one or more kinds of fluidized gas, the fluidized gas includes H₂ or one or more kinds of inert gas selected from following gas: such as N₂, He, Ar, Ne, and so on, which can make the bed fluidized.

In present invention, any disclosure without particular description can refer to the prior art, it will be appreciated that those skilled in the art. For example, the operation of seed recycle back into FBR, removing granular silicon product, production sieving and package, and so on, these are not the inventive point of present invention. Otherwise, the fluidized velocity is usually larger than the minimum fluidized velocity U_{mf} for FBR, 1.1 U_{mf}˜3.0U_{mf} is preferred, and 1.2 U_{mf}˜2.0U_{mf} is more preferred. The size of granular silicon seed is usually 50˜1000 μm, 100˜500 μm is preferred; and the size of produced granular silicon product is usually 100˜3000 μm, 800˜2000 μm is preferred.

The disclosure may be more completely understood in consideration of the following detailed description of various embodiments of the disclosure, but they are provided for illustration only, and not for the purpose of limiting.

### EXAMPLE 1

Table 1 shows the details pertaining to an embodiment of the invention where a test run in which a high sphericity seed batch was prepared as a recycle material for a fluidized bed reactor. Two sets of rollers are used, and the upper roll gap width is 2000 μm, the lower one is 1500 μm, the PSD range of feed raw material is 100-2400 μm, and its median diameter is 1135 median diameter, finally the seeds are generated by roll crushing, which median diameter is 857 μm.

TABLE 1

| | | |
|---|---|---|
| Feed Rate | 250 | lb/h |
| Upper Roll Gap Width, x₁ | 2000 | μm |
| Lower Roll Gap Width, x₂ | 1500 | μm |
| dₚ Range, Product Feed to Roll Crusher | 100-2400 | μm |

| | |
|---|---|
| d₅₀ Product Feed to Roll Crusher | 1135 |
| D₅₀ Seed Produced in Roll Crusher | 857 |

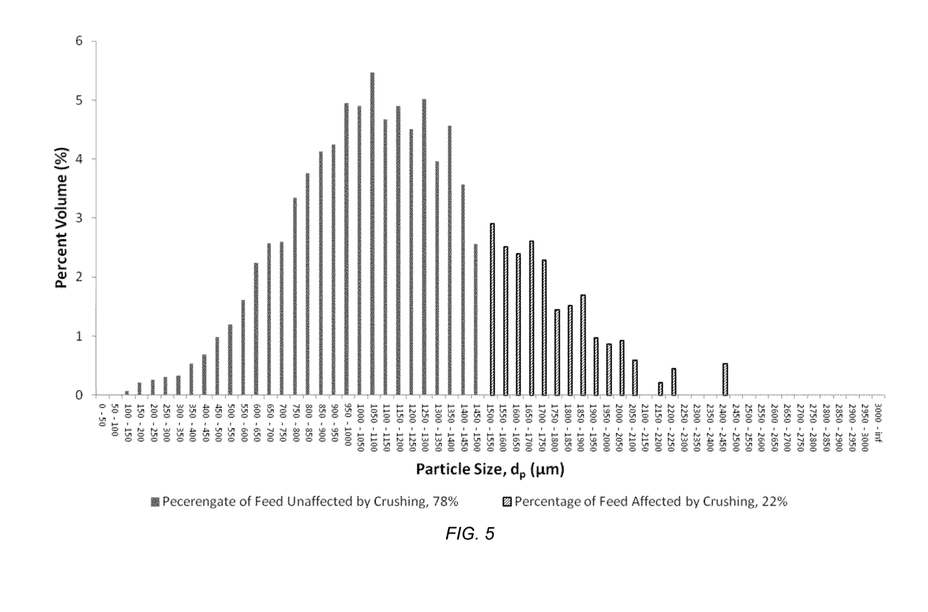

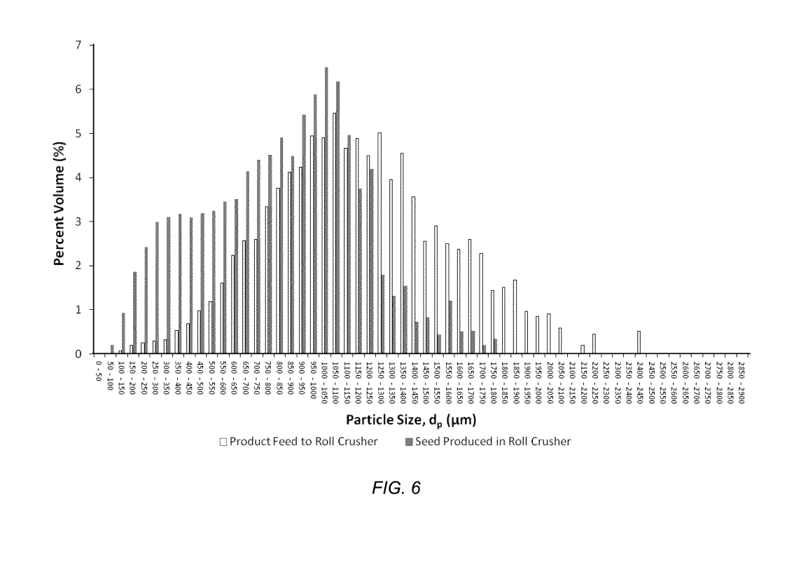

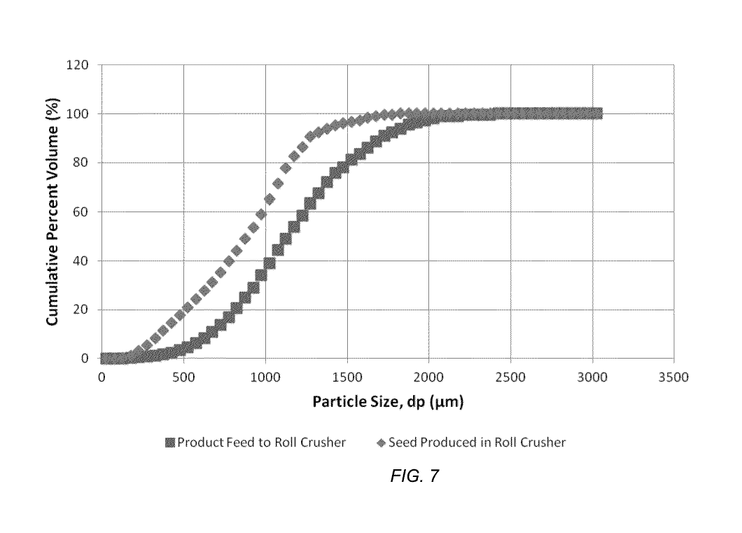

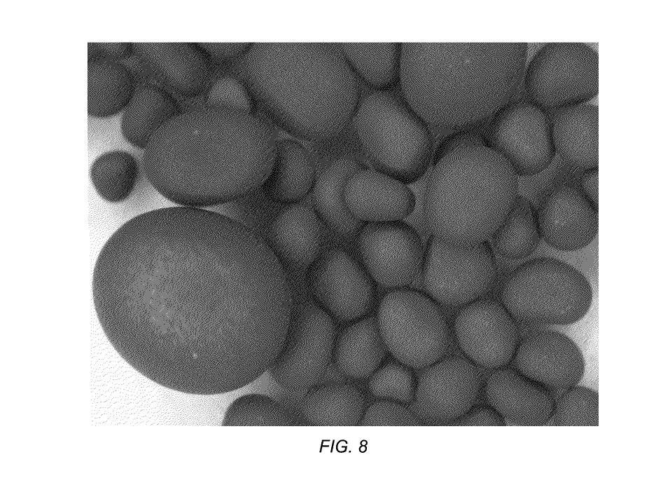

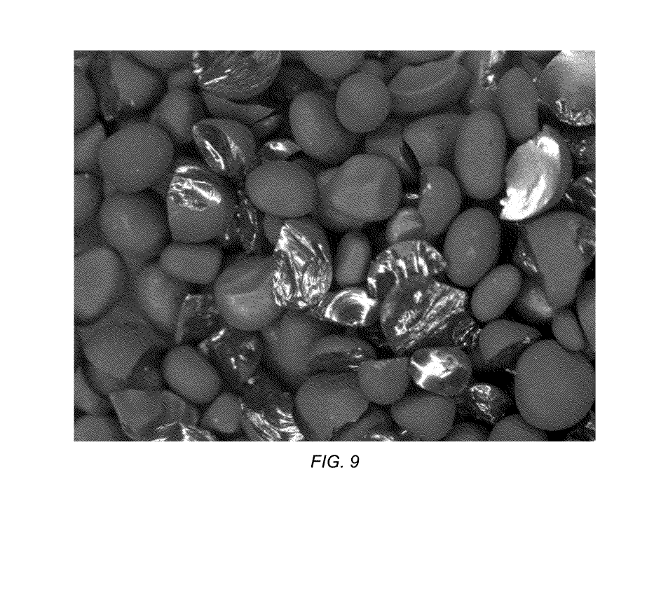

The PSD of the feed to the roll crusher is plotted in FIG. 5. It is shown that approximately 78% of feed granular silicon pass through the roll crusher apparatus and are uncrushed, only 22% of granular silicon are crushed. The PSD of feed granular silicon before crushing and seed after crushing are shown in FIG. 6. It can be seen that big silicon particles are crushed into small particles, and the PSD range of seeds is narrowed. FIG. 7 displays the same particle size distribution data plotted as a cumulative volume percent. It can be seen that the size of particles become smaller, and the number of same size particles become larger. FIGS. 8&9 are images of the feed granular silicon and silicon particles generated based on the embodiment of the invention described in Example 1. Both images were taken at 13.4× magnification. It can be observed in FIG. 8 that the sphericity of particles is good, but they are combination of small and large particles, and have a broad PSD range. After roll crushing, in FIG. 9, note that the cracked particles comprise only a portion of the seed batch, most of particles are uncracked, and its total sphericty is high and has an average particle size.

### COMPARATIVE EXAMPLE 1 (EXAMPLE 2)

Table 2 lists the test details pertaining to a test run in which a comparative study is completed by an alternate grinding method for comparison with an embodiment of the invention.

TABLE 2

| | | |
|---|---|---|
| Feed Rate | 250 | lb/h |
| dₚ Range, Product Feed to Roll Crusher | >2400 | μm |

| | |
|---|---|
| d_{p, 50} Seed Product in Roll Crusher | 858 |

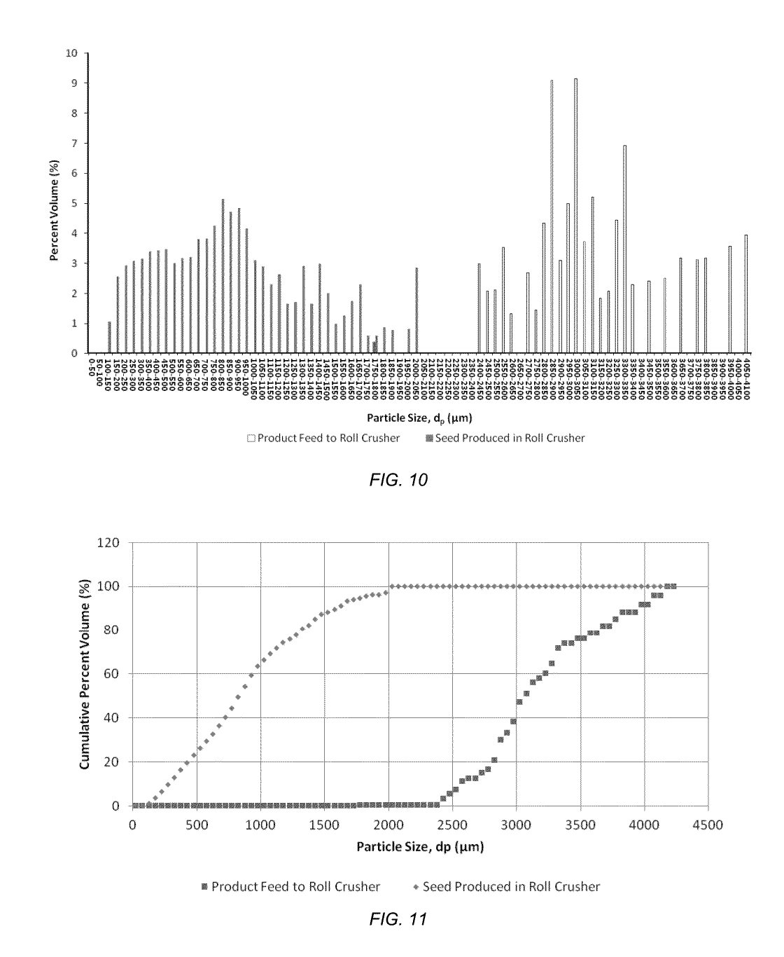

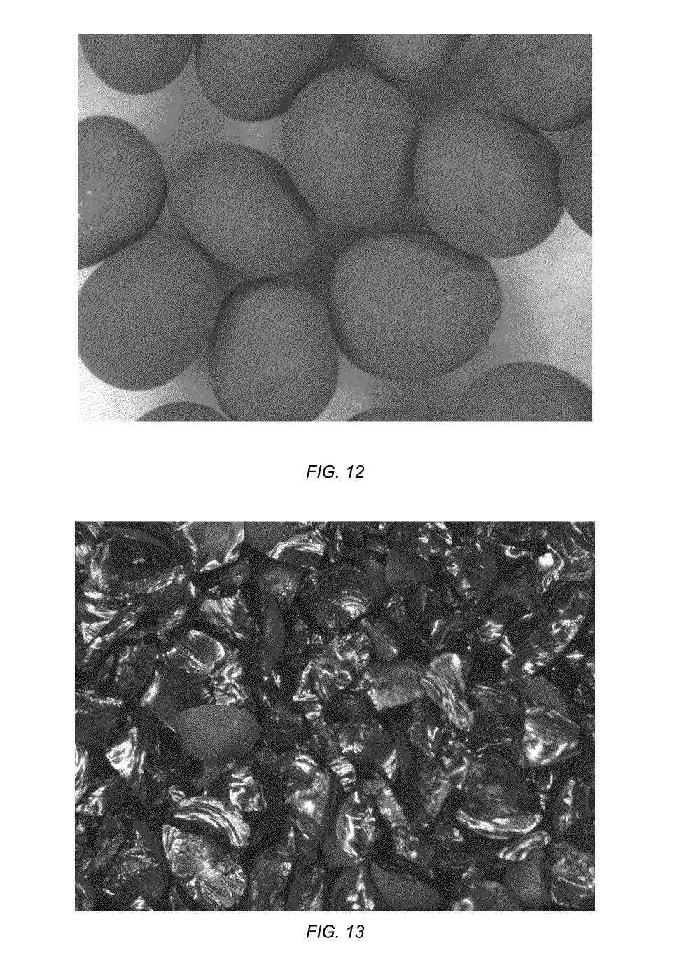

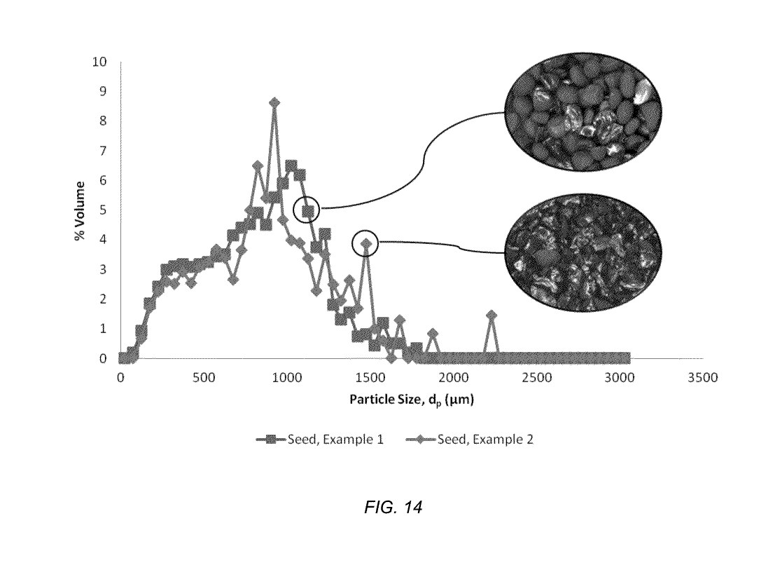

FIG. 10 show the PSD of the feed material and the seed generated by grinding. In this example, the feed material is of larger size than in the embodiment described in Example 1, so each particle is affected by the grinding process and cracked to small particles. FIG. 11 displays the same particle size distribution data plotted as a cumulative volume percent, it's easier to find that the particles bigger than 2400 μm are all cracked to the size smaller than 2000 μm. FIGS. 12&13 are images of the silicon particles from the granular silicon and seed after grinding, taken at 13.4× magnification. It can be seen that the granular silicon has a high sphericity and average size, but all are cracked after grinding, and has a low sphericity. FIG. 14 provides a direct comparison of seed PSD's from an embodiment of the invention described in example 1 and comparative example 1. Note that a similar particle size distribution was produced by both methods, yet the shape factors are very different. Specifically, the sphericity of the seed products produced by the embodiment described in example 1 was higher than that of the seed products produced by comparative example 1.

The voidage ε (or porosity, Ratio between void volume of silicon particles in the bed to total volume) of prepared seeds in FBR is also disclosed in present invention. Table 3 shows the voidage, at the packed bed and minimum fluidization conditions for each seed batch, such as typical product, seed from Example 1 and seed from Comparative Example 1. This data is given in comparison to a typical polysilicon granule product batch from a fluidized bed reactor.

TABLE 3

| | Packed Bed Porosity % | Porosity at U_{mf} % |
|---|---|---|
| Typical Product | 33.5 | 35.3 |
| Seed from Example 1 | 35.7 | 45.7 |
| Seed from Comparative | 43.4 | 54.7 |
| Example 1 | | |

In both examples, the seed exhibits a higher voidage compared with a typical product. At minimum fluidization it can be seen that the seed batch from Comparative Example 1 has porosity that is 19.4% higher than the product porosity. The seed from the embodiment described in Example 1, however, provides a less severe difference in porosity at minimum fluidization, which is 10.4% higher than the product porosity. Thus, compared to the conventional grinding method, the porosity of the seed prepared in the present invention is lower, and easier to avoid the formation of silicon powder and other negative impact.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A method for generating high spherical seed, comprising using a certain particle size distribution range of granular silicon as a raw material, passing through a roll crusher apparatus to fracture, characterized in that: the roll crusher apparatus comprises at least one set of rollers, by adjusting a roller gap width between the at least one set of rollers, silicon particles which size larger than the roller gap width are crushed, the silicon particles which size smaller than the roller gap width directly pass through the gap, thereby generating the high sphericity seed.

2. The method as claimed in claim 1, characterized in that the roller gap width, a median diameter d₅₀ of granular silicon raw material and a median diameter D₅₀ of target seed satisfy the following relationship: 100 μm<D₅₀<d₅₀<x<2400 μm, wherein the granular silicon particle size distribution range dₚ is 100 μm to about 2400 μm and x is the roller gap width.

3. The method as claimed in claim 2, characterized in that the roll crusher apparatus comprises two sets of rollers, the two sets of rollers positioned vertically, the raw material of granular silicon products pass through the two sets of rollers.

4. The method as claimed in claim 3, characterized in that an upper roll gap width x₁ and a lower roll gap width x₂ satisfy the following relationship: x₁≧x₂, wherein x₁ is the upper roll gap width, x₂ is the lower roll gap width.

5. A method for generating fluidized bed granular silicon comprising:
introducing a silicon source gas and a fluidized gas into a fluidized bed reactor (FBR) within which silicon seeds are loaded, where a thermal decomposition reaction is carried out continuously under 500° C. to about 1200° C. reaction temperature, and granular silicon products are prepared from depositing silicon on a surface of the silicon seeds;
withdrawing a portion of the prepared granular silicon products from the FBR and sending to package as a final product;
withdrawing a portion of the granular silicon products from the FBR and sending to generate the high spherical granular silicon seeds by the method of claim 1, and the silicon seeds are recycled back into the FBR, in order to maintain the number of particles constant within the fluidized bed.

6. The method as claimed in claim 5, characterized in that the silicon source gas can be selected from SiHₐX_{b}, wherein, X=F, Cl, Br, I, a or b is selected independently from a=0 to 4, b=0 to 4, and a+b=4.

7. The method as claimed in claim 6, characterized in that the silicon source gas is silane.

8. The method as claimed in claim 6, characterized in that the silicon source gas is chlorosilane.

9. The method as claimed in claim 8, characterized in that the silicon source gas is TCS.
